(19) United States
(12) Patent Application Publication
(10) Pub. No.: US 2026/0286553 A1
(43) Pub. Date: Sep. 24, 2026

(54) SUPERHYDROPHILIC NANOSTRUCTURE ARRAY FOR WATER ELECTROLYSIS, PROCESS OF PRODUCING THEREOF, AND APPLICATIONS THEREOF

(71) Applicant: COUNCIL OF SCIENTIFIC AND INDUSTRIAL RESEARCH, New Delhi (IN)

(72) Inventors: Sidharth BARIK, Pune (IN); Geeta Pandurang KHARABE, Pune (IN); Rajith ILLATHVALAPPIL, Pune (IN); Sreekumar KURUNGOT, Pune (IN)

(73) Assignee: COUNCIL OF SCIENTIFIC AND INDUSTRIAL RESEARCH, New Delhi (IN)

(21) Appl. No.: 19/476,276

(22) PCT Filed: Apr. 19, 2024
(86) PCT No.: PCT/IN2024/050411

§ 371 Date: Oct. 17, 2025

(30) Foreign Application Priority Data
Apr. 20, 2023 (IN) 202311028943

(51) Int. Cl. C25B 11/091; C23C 18/12; C25B 9/19; C25B 11/031; C25B 11/053; C25B 11/054; C25B 11/061

(52) U.S. Cl. CPC C25B 11/091; C23C 18/1216; C23C 18/1225; C23C 18/1241; C23C 18/1266; C25B 9/19; C25B 11/031; C25B 11/053; C25B 11/054; C25B 11/061

(57) ABSTRACT

The present disclosure relates to a hydrophilic composite, comprising 2nd bimetallic component M3M4 (e.g. CoMoO4) deposited on 1st bimetallic component M1M2 (e.g. NiMoO4), supported on a support (e.g. Ni foam) (also termed as M3M4Oy@M1M2Ox/support); wherein the composite has dual structural property without the need of binder/additive and to a process of preparing the hydrophilic composite (M3M4Oy@M1M2Ox/support) and uses thereof. The present disclosure also relates to the environmentally benign production of green hydrogen through HER (hydrogen evolution reaction), and OER (oxygen evolution reaction) reactions using M3M40y@M1M2Ox/support as cathode or anode or both.

### TECHNICAL FIELD OF THE INVENTION

The present disclosure relates to a hydrophilic composite, comprising 2^{nd} bimetallic oxides component (M₃M₄Oy) deposited on 1^{st} bimetallic oxides component (M₁M₂Ox), supported on a support (also termed as M3M4Oy@M1M2Ox/support); wherein the composite has dual structural property i.e., nanoparticles shaped 2^{nd} bimetallic oxides component onto nanorod shaped 1^{st} bimetallic oxides without the need of binder/additive and to a process of preparing the hydrophilic composite (M₁M₂Ox@M₃M₄Oy/support) and uses/applications thereof.

### BACKGROUND AND PRIOR ART OF THE INVENTION

The depletion and inadequacy of non-renewable energy sources with environmental consequences due to emission of greenhouse gases drive the need for a cost-effective method to produce clean energy. Fuel cell (H₂—O₂) technology needs hydrogen as feeding gas and produces electricity and environmentally friendly by-products. But the H₂ production by steam reforming process is an energy intensive process which requires higher temperature and pressure, also producing carbonaceous by-products like CO and CO₂ etc.

In literature, for the generation of H₂ and O₂, electrochemical reaction is done by water splitting which includes HER (hydrogen evolution reaction −2 H⁺+2 e—→H₂, is the cathodic reaction), and OER (oxygen evolution reaction) reactions. Such reactions have many limitations like higher energy requirement, conventionally available catalysts are costly and not reliable, wettability is poor, exposure time, bubble entrapment at electrode active sites, etc. Water electrolysis can be a solution to produce hydrogen in a green method. But the sluggish kinetics of oxygen evolution reaction (OER) in both media (acidic and basic) and hydrogen evolution reaction (HER) in basic media is hindering the water electrolyzer efficiency. The commercial catalyst available for OER is RuO₂ and IrO₂. For HER, Pt/C is the commercial catalyst. But, the issue with this commercial catalyst is high cost, durability, and scarcity.

One of literature known method (Qin Xu et al., ACS Appl. Mater. Interfaces 2022, 14, pages 19448-19458) disclose a NiP₂@MoO₂/Co(Ni)MoO₄ catalyst which has higher hydrophilicity for water splitting, however this is not preferable considering its process requires higher annealing temp., and limited to HER reaction only.

There are additional articles such as a) Chandu V. V. Muralee Gopi et al., Journal of Energy Storage, Volume 30, August 2020, 101550 which reports NiMoO4-CoMoO4 based electrode exhibits a flower-like heterostructures constructed with interconnected nanosheet arrays synthesized by chemical bath deposition for supercapacitor applications; b) Sanming Chen et al., Journal of Electroanalytical Chemistry, Volume 846, 1 Aug. 2019, 113153 reports NiMoO4 @CoMoO₄ synthesized by hydrothermal followed by thermal treatment for solid state supercapacitor applications; c) Yan Wang et al., ACS Appl. Mater. Interfaces 2022, 14, 8282-8296 reports hierarchical, ultrathin, and porous NiMoO₄@CoMoO₄ on Co3O4 hollow bones (Co₃O₄@NiMoO₄@CoMoO₄) were successfully designed and synthesized by a hydrothermal route from the Co-precursor, followed by a KOH (potassium hydroxide) activation process for electrochemical energy storage; and d) Mao-Cheng Liu et al., J. Mater. Chem. A, 2013, 1, 1380 reports CoMoO_{→}-NiMoO₄·xH2O bundles were designed and synthesized by a facile coprecipitation strategy for supercapacitors.

However, the above-mentioned reports are different in application point of view, synthesis procedure and also have a different morphological tuning which definitely affects the electrochemical behavior. In present work, the unique combination of nanorods and nanoparticles disclosed in present composite provides several advantages as disclosed throughout specification. Also, it is not preferable or favorable to suppress NiMoO₄ as mentioned in above known methods. So, there is an urgent need to replace these commercial catalysts by a highly robust, low-cost catalyst with advantageous effects. Another factor is self-standing binder-free bifunctional catalyst is in need, which denotes that if the catalyst is mono-functional, there is a requirement of two catalysts in both anode and cathode, so the cost and maintenance is prohibitive and difficult.

The present work provides an effective composite based on M3M4Oy@M1M2O·xH2O address above problems of literature known reports, along with it shows bifunctional behavior and superhydrophilicity character due to the roughness factor and controlled optimization during synthesis.

### OBJECTS OF THE INVENTION

The general object of the present disclosure is to provide a highly robust, low-cost catalyst for the water electrolyzer for environmentally benign production of green hydrogen.

An object of the present disclosure is to provide a binder-free superhydrophilic nanostructure array enabling efficient overall water electrolysis for environmentally benign production of green hydrogen.

Another object of the present disclosure is to provide a binder-free and self-supported bifunctional electrode comprising superhydrophilic nanostructure array required for reducing the ohmic loss, easy operation and handling of the water electrolyzer.

Yet another object of the present disclosure is to provide a process of preparing a binder-free and self-supported bifunctional electrode comprising superhydrophilic nanostructure array for water electrolyzer.

### SUMMARY OF THE INVENTION

Aspects of the invention relates to a hydrophilic composite for production of H₂ via water electrolysis/splitting, comprising 1^{st} bimetallic oxides component M1M2Ox deposited on 2^{nd} bimetallic oxides component M3M4Oy, supported on a 3D-conductive substrate (also termed as M3M4Oy@M1M2Ox/support); wherein the composite has dual structural property i.e., nanoparticles shaped 2^{nd} bimetallic component is deposited onto the nanorod shaped 1^{st} bimetallic component without the need of binder/additive.

In an aspect, the present invention provides a binder-free superhydrophilic composite for water electrolysis, said superhydrophilic composite comprises:
1^{st} bimetallic oxides component represented by: M₁M₂Ox,
2^{nd} bimetallic oxides component represented by: M₃M₄Oy, and
a 3D conductive support;
   wherein said 2^{nd} bimetallic oxides component is deposited onto said 1^{st} bimetallic oxides component, wherein M₁ is Ni; M₂ is selected from Co, Fe, and Mo; M₃ is selected from Co, Mn, Fe, and Cr; M₄ is selected from Mo, Co, Ni, Zn and W; x is in range of 1-9; and y is in range of 1-9, and wherein, the 1^{st} bimetallic oxides component is in a nanorods shape, and the 2^{nd} bimetallic oxides component is in nanoparticles shape.

In an embodiment, the 1^{st} bimetallic oxides component is NiMoO⁴; and wherein the 2^{nd} bimetallic oxides component is CoMoO4.

In an embodiment, the 3D conductive support is selected from the group consisting of nickel Foam (NF), carbon cloth, titanium foil, copper foam, nickel mesh; wherein the M₁M₂Ox or NiMoO⁴ nanorods has a thickness in the range of 180-400 nm; and the M₃M₄Oy or CoMoO⁴ nanoparticles has a particle size in the range of 50-250 nm.

In an embodiment, the superhydrophilic composite comprises CoMoO₄·xH₂O nanoparticles deposited on NiMoO₄ nanorods that are supported on a nickel foam (CoMoO₄@Ni—MoO₄·xH₂O/NF).

In an aspect, the present invention provides a process of producing superhydrophilic composite comprising the steps of:
a. synthesizing a hydrophilic construction of M1M2Ox·xH2O nanorods on a support substrate by a hydrothermal method at 100-200° C. for 4 to 8 hrs; and
b. growing the M3M4Oy nanoparticles in-situ on the hydrophilic M1M2Ox·xH2O nanorods at 150-200° C., followed by washing and drying to obtain said hydrophilic composite (M3M4Oy@M1M2Ox/support).

In another aspect, the present invention also provides a process of producing NiMoO₄@Co—MoO₄·xH₂O/NF comprising the steps of:
a. providing Ni(NO₃)₂·4H₂O, (NH₄)₆Mo₇O₂₄·4H₂O and Co(acac)₂·6H₂O precursors;
b. synthesizing hydrophilic construction of hydrophilic NiMoO₄·xH₂O nanorods on NF substrate using Ni(NO₃)₂·4H₂O precursor solution at pH of 6.7 as initiator for nanorod formation in presence of (NH₄)₆Mo₇O₂₄·4H₂O at 100-200° C. for 6 h; and
c. growing the CoMoO4 nanoparticles in-situ on the hydrophilic NiMoO4·xH2O nanorods using Co(acac)₂·6H₂O and (NH₄)₆Mo₇O₂₄.4H₂O at at 150-200° C., followed by washing and drying to obtain CoMoO4@NiMoO4·xH2O/NF.

In an embodiment, the ratio of Ni(NO₃)₂·4H₂O and (NH₄)₆Mo₇O₂₄·4H₂O homogenous solution in step b) is 4:1 to 12:3 M, respectively; and wherein ratio of Co(acac)₂·6H₂O and (NH₄)₆Mo₇O₂₄·4H₂O homogenous solution in step c) is 3:1 to 12:3 M, respectively.

In another aspect, present invention provides a binfunctional electrode for water hydrolysis and production of green hydrogen through hydrogen evolution reaction and oxygen evolution reaction in electrochemical device, comprising binder-free superhydrophilic composite, wherein the electrode is cathode and/or anode; and wherein said composite is coated onto electrode.

In an embodiment, the electrochemical device exhibits overpotential of 180 mV to reach current density of 10 mA cm⁻² during oxygen evolution reaction; and overpotential of 356 mV to reach current density of 100 mA cm⁻² during hydrogen evolution reaction.

In an embodiment, the cathode is made of NiFeO4, NiCo2O4 or MnCo2O4; and the anode is made of CoMoN, FeMoO4 or CoWO4.

In another aspect, the present invention provides a half-cell comprising the binfunctional as working electrode (WE), graphite rod as counter electrode and Hg/HgO as reference electrode.

In another aspect, the present invention provides a full-cell comprising the binfunctional electrode as anode and/or cathode, separator and electrolyte solution.

In an embodiment, separator can is based on alkaline exchange membrane, selected from Fumatech F-PAA, Sustanion and Piper ion grade; and wherein the electrolyte solution comprises aqueous solution of 1M KOH.

In yet another aspect, the present disclosure relates to a CoMoO4@NiMoO4·xH2O/NF system acting as bifunctional electrode such as cathode, anode or both for environmentally benign production of green hydrogen through HER (hydrogen evolution reaction), and OER (oxygen evolution reaction) reactions.

In yet another aspect, the present disclosure relates to a half-cell (FIG. 1A) or full cell (FIG. 1B) comprising the CoMoO₄@NiMoO₄·xH₂O/NF system as cathode, anode or both for environmentally benign production of green hydrogen through HER (hydrogen evolution reaction), and OER (oxygen evolution reaction) reactions.

### BRIEF DESCRIPTION OF THE DRAWINGS

FIG. 1 depicts the half fuel cell and full fuel cell comprising cathode, anode, said M3M4Oy@M1M2Ox/support

FIG. 2 depicts the Schematic illustration of the synthesis process for hierarchical CoMoO₄@Ni—MoO₄·xH₂O/NF material and its employment as electrode in Overall water splitting.

FIG. 3 depicts the FE-SEM images: a) Bare NF, b) NiMoO₄·xH₂O/NF with the inset image showing magnified portion, c) High magnification image of the highlighted portion in (b), (d) shows CoMoO₄@NiMoO₄·xH₂O/NF with the inset showing magnified portion, e) High magnification image of the highlighted portion in (e) and f) SEM-EDX elemental mapping of CoMoO₄@NiMoO₄·xH₂O/NF CoMoO4@NiMoO4·xH2O/NF indicating the uniform distribution of Nickel, Molybdenum, Cobalt, and Oxygen.

FIG. 4 depicts the High-resolution transmission electron microscopy (HR-TEM) of CoMoO₄@NiMoO₄·xH₂O/NF: (a) shows NiMoO4·xH2O covered with CoMoO4 nanoparticle, (b) High magnification image, (c) shows d-spacing value of NiMoO4 and (d) CoMoO4 (inset SAED pattern), (e) EDS line scan, (f) CoMoO4@NiMoO4·xH2O/NF image and (g-k) respective elemental mapping of Co, Mo, Ni, O, and overlay shows the uniform distribution.

FIG. 5 depicts the Digital images of contact angle analysis: (a) bare NF and (b) CoMoO4@NiMoO4·xH2O/NF shows highly hydrophilic nature.

FIG. 6 depicts Tomography images CoMoO4@NiMoO4·xH2O/NF (a) 2D-Tomography image, (b and c) 3D volume-rendered images showing different particle size in micrometre scale, (d) 3D tomography images showing the NF skeleton and uniformly distributed active site e) Particle size distribution curve of NiMoO4·xH2O/NF from X-ray computed tomography.

FIG. 7 depicts (a) Comparative OER polarization curves of the catalysts with a scan rate of 2 mV s⁻¹ in N₂ saturated 1 M KOH environment b) Bar diagram corresponding to the OER overpotential at 10 mA cm⁻² current density c) Comparison of EIS analysis of the catalysts in 1 M KOH solution at an overpotential of 330 mV and the inset shows the EIS plot at small scale d) Comparison of Tafel plots of catalysts e) chronoamperometric response of CoMoO4@NiMoO4·xH2O/NF for OER in 1 M KOH solution for 24 h long operation at a current density of 20 mA cm⁻²

FIG. 8 depicts (a) Comparative HER polarization curves of the catalysts with a scan rate of 2 mV s⁻¹ in N₂ saturated in 1 M KOH environment b) Bar diagram corresponding to the HER overpotential at 100 mA cm⁻² current density c) Comparison of EIS analysis of the catalysts in 1 M KOH solution at an overpotential of 330 mV and the inset shows the EIS plot at small scale d) Tafel plots comparison of samples e) chronoamperometric analysis of CoMoO4@NiMoO4·xH2O/NF for HER in 1 M KOH solution for 24 h long operation at a current density of 20 mA cm⁻²

FIG. 9 depicts a) Schematic representation of water electrolyzer based on CoMoO4@NiMoO4·xH2O/NF b) LSV comparison of samples recorded in 1 M KOH solution at a scan rate of 2 mV s⁻¹. C) Bar diagram shows overall water splitting activity comparison of CoMoO4@Ni—MoO4·xH2O/NF with state-of-the-art catalyst. d) chronoamperometric response of Co—MoO4@NiMoO4·xH2O/NF based water electrolyzer in 1 M KOH solution for 24 h long operation at a current density of 50 mA cm⁻².

FIG. 10 shows the faradic efficiency of CoMoO4@NiMoO4·xH2O/NF composite in evolution of H₂ and O₂ after 5400 s (1.5 h) interval is 99% and 62.3%. The comparative difference in faradic efficiency of evolved O₂ compared to evolved green H₂ is due to the surface structural modification during overall water splitting confirmed by post 24 h OWS-CA analysis of respective electrode.

Source of biological material: No Biological materials used in present invention.

### DETAILED DESCRIPTION OF THE INVENTION

The invention will now be described in detail in connection with certain preferred and optional embodiments, so that various aspects thereof may be more fully understood and appreciated. Embodiments of the invention relates to a hydrophilic composite for production of H₂ via water electrolysis/splitting, comprising 2^{nd} bimetallic component M3M4 deposited on 1^{st} bimetallic component M1M2, supported on a 3D-conductive substrate (also termed as M3M4Oy@M1M2Ox/support); wherein the composite has dual structural property i.e., nanorod shaped 1^{st} bimetallic component onto nanoparticles shaped 2^{nd} bimetallic component (nanorods@nanoparticles/support) without the need of binder/additive.

In an embodiment of the present disclosure, the x and y of M3M4Oy@M1M2Ox are 4 and 4, respectively.

In an embodiment of the present disclosure, the M1 is selected from but not limited to Ni (Nickel).

In an embodiment of the present disclosure, the M2 is selected from the group consisting of but not limited to Co, Fe, Mo, and the like.

In an embodiment of the present disclosure, the M1M2 component is selected from but not limited to NiMoO4, wherein the oxidation level of Ni is +2 and +3 and Mo is +6.

In an embodiment of the present disclosure, the M3 is selected from the group consisting of but not limited to Co, Mn, Fe, Cr and the like.

In an embodiment of the present disclosure, the M4 is selected from the group consisting of but not limited to Mo, Co, Ni, Zn, W and the like.

In an embodiment of the present disclosure, the M3M4 component is selected from but not limited to CoMoO4, wherein the oxidation level of Co is +2 and +3 and Mo is +6.

In an embodiment of the present disclosure, the 3D-conductive substrate is selected from the group consisting of but not limited to Ni Foam, carbon cloth, Ti foil, Cu foam, Ni mesh, and the like. Preferably Ni Foam (NF), is used as the conductive support due to its high surface area, good electrical conductivity, and low cost.

In some embodiments of present disclosure, nanorods covered with nanoparticles show thickness ranging in the nanometer scale. In some embodiments, the nanoparticles may have a diameter of at least about 1 nm, 10 nm, 50 nm, 100 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2500 nm, 3000 nm, 4000 nm, 5000 nm, 6000 nm, 7000 nm, 8000 nm, or at least 9000 nm. In some embodiments, nanoparticles may have diameter of less than 10,000 nm, 9000 nm, 8000 nm, 7000 nm, 6000 nm, 5000 nm, 4500 nm, 4000 nm, 3500 nm, 3000 nm, 2500 nm, 2000 nm, 1900 nm, 1800 nm, 1700 nm, 1600 nm, 1500 nm, 1400 nm, 1300 nm, 1200 nm, 1100 nm, 1000 nm, 900 nm, 800 nm, 700 nm, 600 nm, 500 nm, 250 nm, or less than 100 nm. Diameter of nanoparticles can range from any of minimum values described above to any of the maximum values described above, for example from 1 nm to 10,000 nm, 50 nm to 5,000 nm, 100 nm to 2500 nm, 200 nm to 2000 nm, or 500 nm to 1000 nm. Preferably, from about 50 nm to about 500 nm. Most preferably 180 nm to 400 nm.

In some embodiments of the present disclosure, the nanorods show a thickness ranging in the nanometer scale. In some embodiments, the nanocomposite granules may have a diameter of at least about 1 nm, 10 nm, 50 nm, 100 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2500 nm, 3000 nm, 4000 nm, 5000 nm, 6000 nm, 7000 nm, 8000 nm, or at least 9000 nm. In some embodiments, the nanoparticles may have a diameter of less than 10,000 nm, 9000 nm, 8000 nm, 7000 nm, 6000 nm, 5000 nm, 4500 nm, 4000 nm, 3500 nm, 3000 nm, 2500 nm, 2000 nm, 1900 nm, 1800 nm, 1700 nm, 1600 nm, 1500 nm, 1400 nm, 1300 nm, 1200 nm, 1100 nm, 1000 nm, 900 nm, 800 nm, 700 nm, 600 nm, 500 nm, 250 nm, or less than 100 nm. The diameter of nanoparticles can range from any of the minimum values described above to any of the maximum values described above, for example from 1 nm to 10,000 nm, 50 nm to 5,000 nm, 100 nm to 2500 nm, 200 nm to 2000 nm, or 500 nm to 1000 nm. Preferably, from about 1 nm to about 500 nm. Most preferably 160 nm to 380 nm.

In an embodiment, the present disclosure provides a self-supported active site engineered superhydrophilic hierarchical CoMoO4@NiMoO4·xH2O/NF nanostructure on nickel foam (NF) without the need of binder/additive.

In another embodiment, the M3M4Oy nanoparticles is deposited partially or fully over the M1M2Ox nanorods.

In an embodiment, the present disclosure relates to a process of preparation of said hydrophilic composite (also termed as M3M4Oy@M1M2Ox/support) without the need of binder/additive to have a hydrophilic electrode, via two-step hydrothermal process.

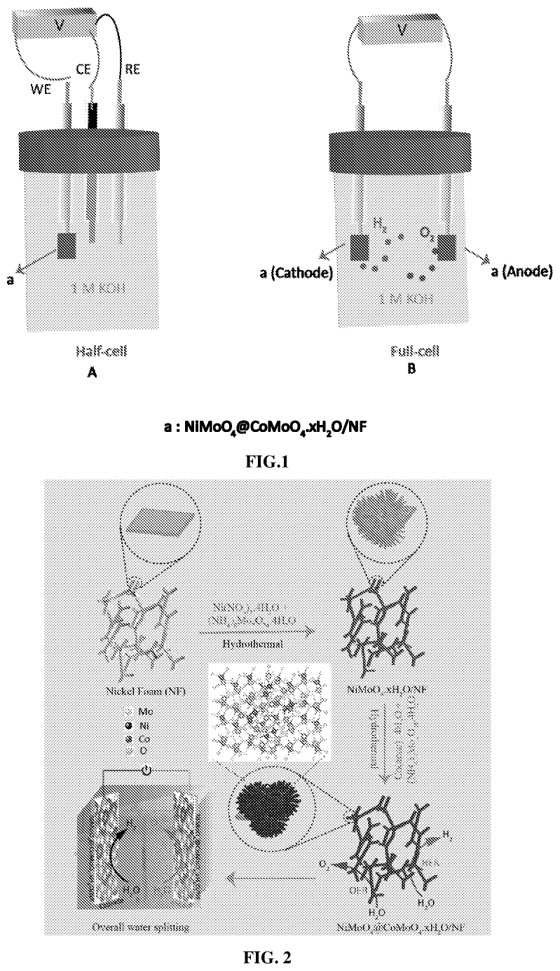

In an embodiment, the present disclosure relates to a process of preparation of said hydrophilic the CoMoO4@NiMoO4·xH2O/NF composite is directly grown on the NF surface (FIG. 2) to form the ordered structure without the need of binder/additive to have a hydrophilic electrode, via two-step hydrothermal process.

In an embodiment, the present disclosure provides a process for producing NiMoO4@Co—MoO4·xH2O/NF system comprising:
c. synthesizing hydrophilic construction of NiMoO4·xH2O nanorods on NF substrate by a straight forward hydrothermal method at 100-200° C. for 6 h; and
d. growing the CoMoO4 nanoparticles in-situ on the hydrophilic NiMoO4·xH2O nanorods at 150-200° C., followed by washing and drying to obtain CoMoO4@NiMoO4·xH2O/NF In some embodiments of the present disclosure, the NiMoO4@CoMoO4·xH2O nanostructure consisting of nanorods@nanoparticles on conductive 3D nickel foam (NF) substrate is synthesized by two-steps simple and scalable hydrothermal synthesis approach by using Ni(NO₃)₂·4H₂O, (NH₄)₆Mo₇O₂₄·4H₂O and Co(acac)₂·6H₂O precursors. Ni(NO₃)₂·4H₂O precursor solution at pH of 6.7 acts as initiator for nanorod formation in presence of (NH₄)₆Mo₇O₂₄·4H₂O at 150° C. The in-situ generated NiMoO₄·xH₂O nanorods catalyse further growth of CoMoO₄ nanoparticles in presence of Co(acac)₂·6H₂O and (NH₄)₆Mo₇O₂₄·4H₂O at 180° C. The hydrophobic NF substrate is converted to hydrophilic by growth of NiMoO₄·xH₂O nanorods in first step of hydrothermal approach. The better morphological construction and hydrophilic nature of NiMoO₄·xH₂O nanorod arrays acts as a “substratum” for coverage of CoMoO₄ nanoparticles (superstratum) in second step of hydrothermal synthesis method.

In some embodiments of the present disclosure, the step a) comprises a homogeneous solution of Ni(NO₃)₂·6H₂O and (NH₄)₆Mo₇O₂₄·4H₂O in the ratio of 4:1 to 12:3, respectively. In some embodiments of the present disclosure, the step b) comprises a homogeneous solution of Co(acac)₂·6H₂O and (NH₄)₆Mo₇O₂₄·4H₂O in the ratio of 3:1 to 12:3 M, respectively. In preferred embodiments of the present disclosure, the step a) comprises a homogeneous solution of Ni(NO₃)₂·6H₂O and (NH₄)₆Mo₇O₂₄·4H₂O in the ratio of 4:1 M, 5:1 M, 6:1 M, 8:1 M, 8:2 M, or 12:3 M, respectively.

In some embodiments, step b comprises homogeneous solution of Co(acac)₂·6H₂O and (NH₄)₆Mo₇O₂₄·4H₂O in ratio of 3:1 M, 4:1, 5:1, 6:2, 8:1 M, 8:3 M, or 12:3 respectively.

In some embodiments of present disclosure, the M3M4Oy@M1M2Ox morphology provides high exposure of interconnected active sites, synergistic interaction between the hybrid counter parts for easy diffusion of ion/electron and homogeneous distribution of active sites provides a suitable pathway for electrode/electrolyte interaction. Further, roughness factor increases the superhydrophilicity for better electrode-electrolyte interaction due to the orientation effect.

In some embodiments of the present disclosure, the CoMoO4@NiMoO4·xH2O/NF system is better exposed for better electrode-electrolyte interaction and exhibit better catalytic activities for the overall water splitting which include HER (hydrogen evolution reaction—2 H⁺+2 e−→H₂, is the cathodic reaction), and OER (oxygen evolution reaction) reactions. The system requires a low OER overpotential of 180 mV to reach a current density of 10 mA cm⁻² whereas, HER requires 203 mV overpotential to deliver the 10 mA cm⁻² current density.

Density functional theory calculations for OER process elucidated that the free energy change (ΔG) of Ni(111) in potential-determining step OOH*→02* is 3.20 eV. But in case of NiMoO₄ (110) and NiMoO₄@CoMoO₄ (CoMoO₄ cluster adsorbed on NiMoO₄), the potential determining step was found to be OH*→O* with free energy change ΔG=1.95 eV and ΔG=1.39 eV respectively. This lowest ΔG of NiMoO₄@CoMoO₄ compared to Ni and NiMoO₄ is due to presence of Co in the OER catalytic site and its synergistic interaction with NiMoO₄

In some embodiments of the present disclosure, the nanorods like morphology of NiMoO4 and its synergistic interaction with nanoparticles like morphology of CoMoO4·xH2O help in better interaction with electrolytes and reactants during electrochemical process. The substratum NiMoO₄·xH₂O nanorods act as highly conductive material and provides better surface area and charge transfer during electrochemical process. Also, the active site modulation as optimizing the metal content creates an interconnected network for better mass transport. Then decoration of CoMoO₄ on NiMoO₄·xH₂O nanorods makes the electrode-electrolyte interaction more feasible for easy release of O₂ gas from the electrocatalytically active surface

In some embodiments of the present disclosure, the CoMoO4@NiMoO4·xH2O/NF system act as bifunctional electrode such as cathode, anode, or both for environmentally benign production of green hydrogen through HER (hydrogen evolution reaction), and OER (oxygen evolution reaction) reactions.

In an embodiment, the present disclosure relates to a half-cell (FIG. 1A) or full cell (FIG. 1B) comprising the CoMoO4@NiMoO4·xH2O/NF system as cathode, anode, or both for environmentally benign production of green hydrogen through HER (hydrogen evolution reaction), and OER (oxygen evolution reaction) reactions. In half-cell NiMoO4@CoMoO4/NF was used as working electrode (WE), graphite rod as counter electrode (CE) and Hg/HgO as reference electrode (RE). In full-cell both cathode and anode were made up of NiMoO4@CoMoO4/NF bifunctional electrode. In both half and full-cell a holder was used to support working electrode. In a nutshell, the inventors of present invention provide a noble metal free electrocatalysts by an in-situ growth of hierarchical M1M2O₄@M3M4O₄·xH2O nanostructure on nickel foam (NF) via. straightforward two-step hydrothermal synthesis method. The binder-free electrode not only possesses electrochemically rich active sites but also possesses good stability. Specifically, CoMoO4@NiMoO4·xH2O/NF shows good electrocatalytic performance for oxygen evolution reaction (OER) and hydrogen evolution reaction (HER) in N₂ saturated 1 M KOH electrolyte. The system requires low OER overpotential of 180 mV to reach a current density of 10 mA cm⁻² whereas, HER requires 203 mV overpotential to deliver 10 mA cm⁻² current density. The overall water splitting was performed by integrating CoMoO4@NiMoO4·xH2O/NF as a cathode as well as anode electrode with a quiet low cell voltage of 1.60 V at 10 mA cm⁻² for overall water splitting compared to state-of-the-art Pt/C@NF | RuO₂@NF which achieve 10 mA cm⁻² at 1.63 V. The better performance and robustness is attributed to the unique hierarchical structure and collaborative advantages among the two hybrid counterparts NiMoO₄·xH₂O and CoMoO₄ on conductive NF substrate. This study shows how transition metal-based oxides with intriguing structural features can be a better candidate to develop an efficient water electrolyzer. Density functional theory calculations for OER process elucidated that the free energy change (ΔG) of Ni(111) in potential-determining step OOH*→02* is 3.20 eV. But in case of NiMoO₄ (110) and NiMoO₄@CoMoO₄ (CoMoO₄ cluster adsorbed on Ni—MoO₄), the potential determining step was found to be OH*→O* with free energy change ΔG=1.95 eV and ΔG=1.39 eV respectively. This lowest ΔG of NiMoO₄@CoMoO₄ compared to Ni and NiMoO₄ is due to the presence of Co in the OER catalytic site and its synergistic interaction with NiMoO₄. The preparative strategy, mechanistic understanding and the synergism between the hybrid counterparts make the windows open for the large-scale production of robust and inexpensive electrode material for overall water electrolysis.

The phase purity and crystallinity of NiMoO₄·xH₂O/NF, CoMoO₄/NF, and CoMoO4@NiMoO4·xH2O/NF were analyzed through XRD and compared with their JCPDS file. In this regard, the patterns of single NiMoO4·xH2O and CoMoO4 are in good agreement with the standard patterns for NiMoO4·xH2O (JCPDF card no. 013-0128) and CoMoO4 (JCPDF card no. 015-0439). The main peaks at 2θ values of 20.88°, 23.37°, 26.90°, 29.35° and 32.97° can be well matched with (200), (021), (002), (310) and (−222) planes of CoMoO4 phase (JCPDF card no. 015-0439). The pattern of NiMoO4@CoMoO4·xH2O contains the diffraction peaks of both NiMoO4·xH2O and CoMoO4, indicating presence of both phases. In addition, several diffraction peaks were attributed to the impurity phase of NiMoO4 (JCPDF card no. 012-0348). From this analysis, it is assumed growth of CoMoO4 nanoparticles over NiMoO4·xH2O nanorods.

As the material is synthesized by hydrothermal synthesis method, there may be the presence of surface bound water molecules, TG-DTA technique gives an insight regarding dehydration process. The overall percentage of weight loss in NiMoO4·xH2O/NF and CoMoO4@Ni—MoO4·xH2O/NF is in the range of 7-8%. The attribution of reversibly bound water molecules below 100° C., which corresponds to an endothermic peak on the DTA curve. The evolution of water molecules that form an integral part of the crystal structure of NiMoO4·xH2O/NF and CoMoO4@NiMoO4·xH2O/NF is attributed to the desorption range 100° C. to 300° C. The exothermic peaks are the characteristic peak of the DTA curves. The peak centres (exothermic peak) at 303° C. and 307° C. correspond to NiMoO4·xH2O/NF and CoMoO4@Ni—MoO4·xH2O/NF respectively.

In another embodiment, the particle size is an important parameter for the exposure of active sites of metals in said composite. For example, less is the particle size, more is the active sites utilization, which impacts on the overall performance. In this work, the electronic modulation by the incorporation of Cobalt (M3) in NiMoO4 (M1M2Ox) crystal phase in the form of CoMoO4 (M3M4Oy), helps in the increase in both HER and OER activity. In some embodiments, the particle size of CoMoO4 ranges from 50-250 nm, for example 50-60, 60-70, 70-80, 80-90, 90-100, 100-110, 110-120, 120-130, 130-140, 140-150, 150-160, 160-170, 170-180, 180-190, 190-200, 200-210, 210-220, 220-230, 230-240, or 240-250 nm.

In addition to above, the inventors of the present application has done the chronoamperometric analysis (CA) of claimed material at a very high current (1000 mA) for 12 h. The higher the current the more the yield of green hydrogen production was attained. Specifically, the NiMo04@CoMoO4·xH2O/NF shows stable performance at 1 A current. Also, inventors uncovered the reason behind the better activity of the material by theoretical investigation and found that the presence of Co in the OER catalytic site and its synergistic interaction with CoMoO4 lower the binding energy value of NiMoO4@CoMoO4 than NiMoO4 and NF. After 24 h of overall water splitting (OWS) CA analysis, there is in situ modification of the nanostructure and the surface CoOOH nanoparticles provide the anchoring sites for the adsorption of the H+ and OH— ions and help to contribute to attaining better structural and functional integrity of the catalysts.

### EXAMPLES

### Experimental Section

Materials: Cobalt acetyl acetonate Co(acac)₂, nickel (II) nitrate hexahydrate Ni(NO₃)₂·6H₂O), ammonium heptamolybdate (NH₄)₆Mo₇O₂₄·4H₂O, potassium hydroxide KOH, ruthenium oxide RuO₂ were purchased from Sigma-Aldrich chemicals. Hydrochloric acid was procured from Thomas Baker. 40% Pt/C was procured from Alfa-Aesar. All the chemicals were used without any further purification. Nickel Foam (NF) of thickness 0.5 mm was procured from Global Nanotechnology pvt. Ltd.

### Example 1: Synthesis of NiMoO₄·xH₂O/NF as M1M2O4/Support Component

NiMoO₄·xH₂O nanorods were synthesized on nickel foam substrate via. One step hydrothermal method. A piece of commercial nickel foam (2.5 cm×3.5 cm) was cleaned in 1 M HCl followed by washed with deionized (DI) water and ethanol each for 10 min sonication. Then it was dried in a vacuum oven at 60° C. for 6 h. After that, cleaned nickel foam (NF) was used as a substrate. The pre-cleaned NF was vertically kept into a Teflon-lined autoclave of capacity 40 mL containing a homogeneous solution of Ni(NO₃)₂·6H₂O (0.04 M) and (NH₄)₆Mo₇O₂₄·4H₂O (0.01 M) in 35 mL of DI water. Afterward, hydrothermal treatment was carried out in oven at 150° C. for 6 h. After natural cooling down to room temperature, the material was cleaned several times with DI water-ethanol mixture (1:1). The obtained material dried at 60° C. for 6 h under a vacuum oven. The obtained material named as NiMoO₄·xH₂O/NF. The mass loading of the NiMoO₄·xH₂O nanorods on NF was calculated by weight gain after reaction which is estimated nearly 28.9 mg cm⁻². The mechanistic understanding for the growth of nanorods instead of nanosheets depends on the reaction temperature. At temperature below or equal to 150° C., MoO₄²⁻ reacts with Ni²⁺ ions in solution and form NiMoO₄·xH₂O nanorods.

### Example 2: Synthesis of CoMoO₄/NF as M3M4O4/Support Component

CoMoO₄ nanosheets were synthesized on nickel foam via. a facile hydrothermal method. A piece of commercial nickel foam (2.5 cm×3.5 cm) was cleaned in 1 M HCl followed by washed with deionized (DI) water and ethanol each for 10 min sonication. Then it was dried in a vacuum oven at 60° C. for 6 h. The pre-cleaned NF was vertically kept into a Teflon-lined autoclave of capacity 40 mL containing a homogeneous solution of Co(acac)₂·6H₂O (0.08 M) and (NH₄)₆Mo₇O₂₄·4H₂O (0.01 M) in 35 mL of DI water. Afterward, hydrothermal treatment was done in oven at 180° C. for 6 h. After natural cooling down to room temperature, the material was cleaned several times with DI water-ethanol mixture (1:1). The obtained material dried at 60° C. for 6 h under a vacuum oven. The obtained material named as CoMoO₄/NF. The mass loading of the CoMoO₄ nanosheets on NF was calculated by weight gain after reaction which is estimated nearly 9 mg cm⁻².

### Example 3: Synthesis of CoMoO₄@NiMoO4·xH2O/NF Composite

For the synthesis of CoMoO4@NiMoO4·xH2O/NF hierarchical heterostructure through two-step hydrothermal synthesis method, the obtained NiMoO₄·xH₂O/NF was kept vertically in a Teflon-lined autoclave capacity of 40 mL containing a homogeneous solution of Co(acac)₂·6H₂O (0.08 M) and (NH₄)₆Mo₇O₂₄·4H₂O (0.01 M) in 35 mL DI water. Afterward, hydrothermal treatment was performed in oven at 180° C. for 6 h. After cooling down to room temperature, the material was cleaned several times with DI water-ethanol mixture (1:1) and dried at 60° C. for 6 h in vacuum oven. The obtained material is named as CoMoO4@Ni—MoO4·xH2O/NF. The mass loading of the NiMoO₄@CoMoO₄·xH₂O nanocomposite on NF was calculated by the weight gain before and after the reaction, which is estimated as approximate 42.85 mg cm⁻². CoMoO₄@NiMoO₄·xH₂O/NF is used as a bifunctional electrode in both anode and cathode for overall water splitting.

### 3.1 Material Characterization

The phase and crystallinity of the samples were examined through a Rigaku 2D X-ray micro diffractometer (Model MicroMax-007HF) equipped with a high-intensity microfocus rotating anode X-ray generator/Analytical X′Pert PRO at a scan rate of 10° C. min⁻¹ in 2θ range of 10 to 80°. The morphological analysis was performed through FEI Nova Nano SEM 450 field-emission scanning electron microscopy (FE-SEM) instrument. High resolution imaging was analyzed using the JEOL JEM F-200 HRTEM instrument. Transmission electron microscopy (TEM) instrument (FEI, TECNAI G2 F20 was used for the high-resolution nanostructural imaging. The X-ray photoelectron spectroscopy (XPS) was characterized on ThermScientific Kat, fully integrated, monochromatic small-spot X-ray Photoelectron Spectroscopy (XPS) system. Quantachrome AsiQwin was used for BET analysis. The contact angle analysis of electrode and electrolyte was performed by optical contact angle system (KRUS drop shape analyzer). Micro-computed X-ray tomography was performed for 3D structure analysis in microscale via Xradia Versa 510 X-ray Microscope (Zeiss X-ray Microscopy, Pleasanton, CA, USA). The surface bound water molecules, and dehydration process was investigated utilizing thermogravimetric analysis (TGA) (SDT Q600 DSC-TDA thermo-gravimetric instrument; temperature range of 10-900° C.; ramp of 10° C. min-1; nitrogen atmosphere).

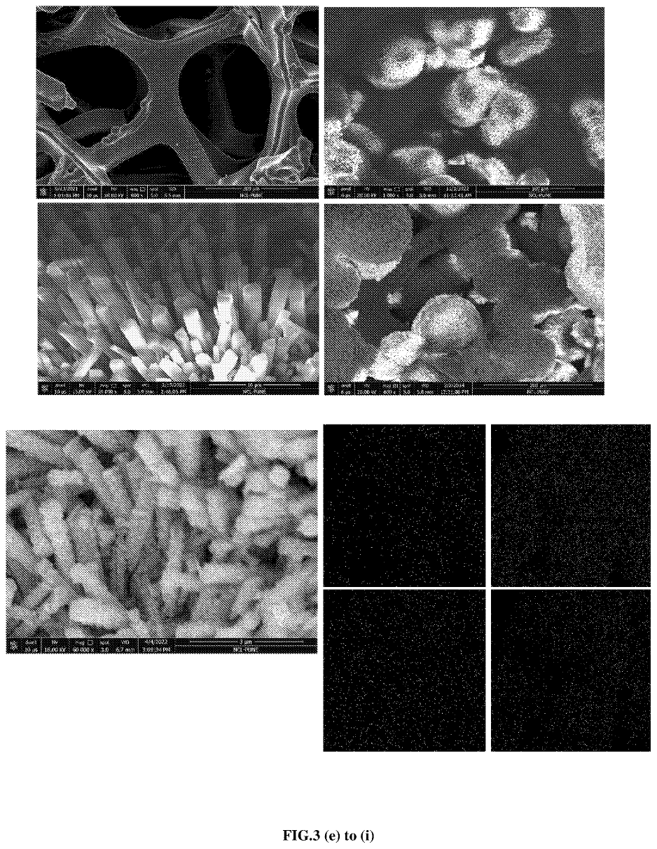

To get structural information of the as-synthesized materials, field-emission scanning electron microscopy (FE-SEM) analysis was performed and the corresponding images are depicted in FIG. 3. FIG. 3a shows the FE-SEM image of bare (NF), which divulges the smooth surface texture of the material. FIG. 3b depicts the in-situ growth of NiMoO₄·xH₂O nanorods on NF (NiMoO₄·xH₂O/NF). The hydrophilic nature of NiMoO₄·xH₂O nanorods and their stable construction act as a backbone for the further growth of CoMoO₄ nanoparticles. The smooth surface texture of NiMoO₄·xH₂O nanorods in FIG. 3c is the enlarged portion of the inset of FIG. 3b. The high-magnification SEM image of CoMoO₄@NiMoO₄·xH₂O/NF in FIG. 3d and its enlarged portion. FIG. 3e clearly shows that the smooth surfaces of the NiMoO₄·xH₂O nanorods synthesized in first step were changed to rough texture because of uniform decoration of CoMoO₄ nanoparticles over NiMoO₄·xH₂O nanorod. For comparison, only one-step hydrothermal synthesis method was implemented to know the nature of growth pattern of CoMoO₄ on NF. It was well observed that nanoparticles like morphology of CoMoO₄ were formed on NF substrate. It is assumed that the morphological variation (nanoparticles on NiMoO₄·xH₂O nanorod and nanoparticles like morphology on NF of CoMoO₄ phase is due to the different arrangement of corresponding ions of precursors on substrate. FIG. 3f-i displays the elemental mapping (SEM-EDX) of CoMoO₄@NiMoO₄·xH₂O/NF, which displays the uniform distribution of Ni, Mo, Co, and O elements.

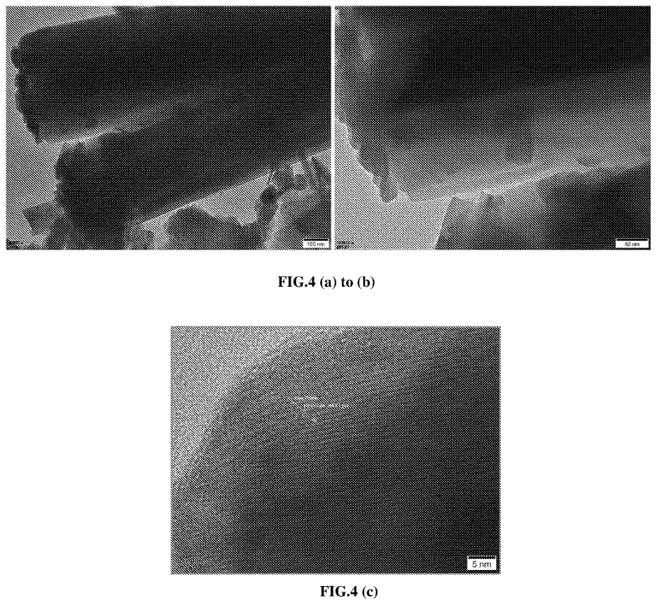

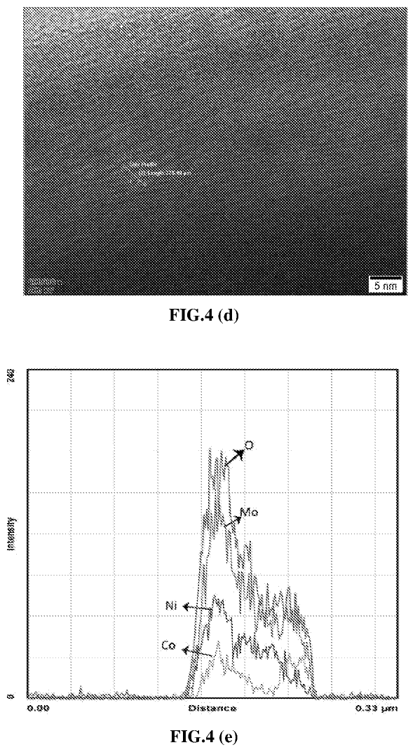

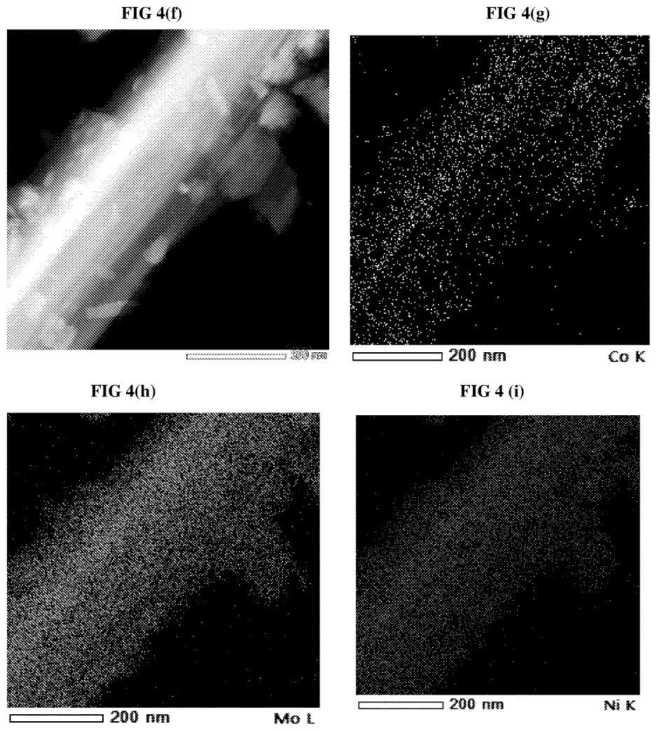

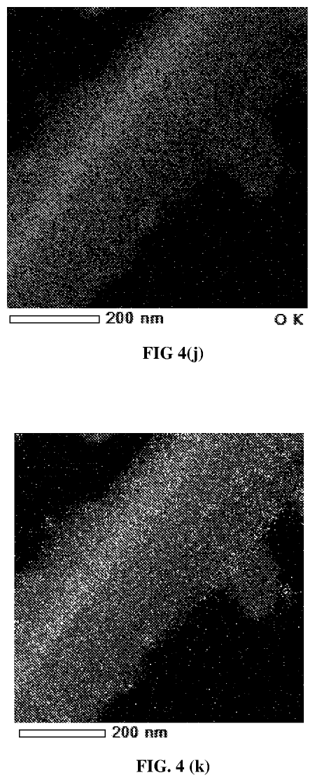

The FIG. 4a, b displays High-resolution transmission electron microscopy (HR-TEM) images of CoMoO₄@NiMoO₄·xH₂O/NF nanorods covered with nanoparticles showing a thickness in the range of 180 to 400 nm at different magnifications. The highlighted parts in FIG. 4b indicate formation of CoMoO₄ nanoparticles over NiMoO₄ nanorod. The HR-TEM image in FIG. 4c, d reveals distinctive lattice fringes with interplanar spacings of 0.40 nm and 0.37 nm, which are corresponding to the (220) and (021) planes of NiMoO₄ and CoMoO₄, respectively. The selected area electron diffraction (SAED) pattern of CoMoO₄@NiMoO₄·xH₂O/NF (inset FIG. 4d), indicates the crystalline nature CoMoO₄@NiMoO₄·xH₂O/NF. The energy-dispersive X-ray spectroscopy (EDS) line scan result (FIG. 4e) and CoMoO₄@NiMoO₄·xH₂O/NF image (FIG. 4f) and respective-elemental mapping analysis (FIG. 4g-k) display that Co, Mo, Ni, and O are, homogeneously distributed throughout the nanorod. For comparative analysis, TEM images of only crystalline NiMoO₄·xH₂O hierarchical nanorods at different magnifications showing a thickness in the range of 160 nm to 380 nm. The corresponding SAED pattern of the sample shows polycrystalline nature and interplanar spacing of 0.55 nm, which is corresponding to (100) plane of NiMoO₄.

The surface wettability of the electrode can be measured by contact angle analysis, which provides information regarding electrode-electrolyte interaction. FIG. 5a depicts the contact angle and its digital image of bare NF with water is 128°, which specifies the highly hydrophobic nature of bare NF.⁵³ The hydrophilic nature of electrodes makes the system active for better electrode-electrolyte interaction, which is a factor for improving electrocatalytic activity. FIG. 5b displays the contact angle measurement of NiMoO₄·xH₂O/NF, CoMoO₄/NF and CoMoO₄@NiMoO₄·xH₂O/NF, respectively specifying the super hydrophilic nature. Due to the fast spreading of water on the surface, contact angle measurement is difficult in FIG. 5b. Also, the contact area of NF is a “hydrophobic zone” due to the bubble effect and after the growth of bunch of nanorods, it became “Superhydrophilic zone.

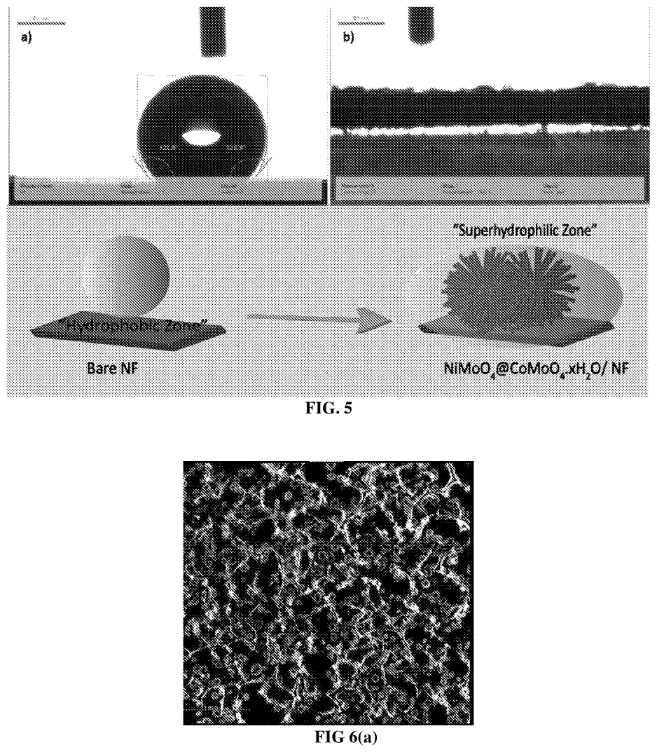

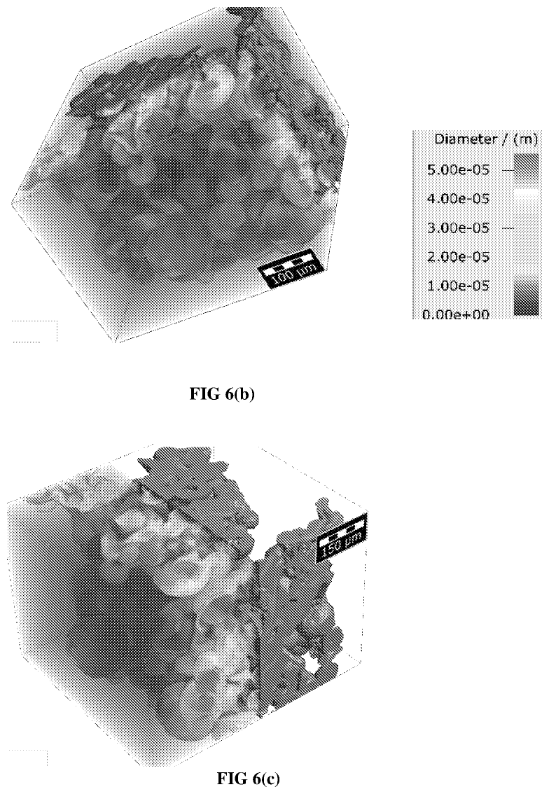

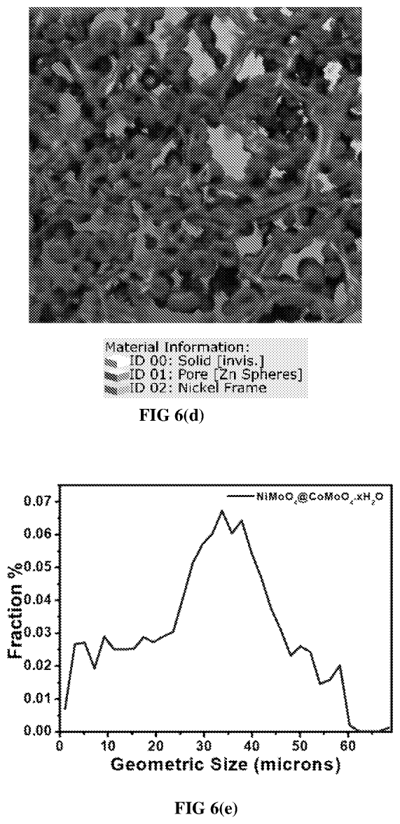

The uniform growth pattern of CoMoO₄@NiMoO₄·xH₂O/NF nanorods@nanoparticles arranged in a spherical construction is well analyzed by tomographic analysis as shown in FIG. 6a-d. The net like skeleton in FIG. 6a-d is of NF substrate. The 2D tomography image in FIGS. 6a and 3D tomography image in FIG. 6b are of CoMoO₄@NiMoO₄·xH₂O/NF. As in the FESEM analysis, the bunches of nanorods (nearly spherical microstructure) are of size in micrometer scale. The 3D volume rendered tomography images in FIG. 6b, c shows the particle size distribution in micrometer scale. FIG. 6e shows the maximum nanorods@nanoparticles of CoMoO₄@NiMoO₄·xH₂O behaving as active sites are distributed on NF is in the range of 20 to 50 micrometer. The active sites should be interconnected for better mass transport, so is a factor for increasing electrocatalytic performance. Herein, the active sites of CoMoO₄@NiMoO₄·xH₂O/NF is well interconnected and the optimum loading of material decorated by in-situ hydrothermal synthesis method to prevent unnecessary agglomeration. So, above factors are properly analyzed by three-dimensional micro-computed tomography, consistent with FESEM analysis.

### 3.2 Electrochemical Analysis

A potentiostat (Bio-Logic-SP-300) was used for the electrochemical analysis of synthesized material in 1 M KOH solution using a three-electrode set-up. The Hg/HgO was used as the reference electrode, graphite rod as the counter electrode, and as prepared self-standing catalysts as the working electrode with an active area of 1*1 cm⁻². The Hg/HgO electrode was calibrated in H₂ saturated 1 M KOH solution. Potentials were referenced with respect to RHE by adding 0.915 V in 1 M KOH solution. The electrochemical cyclic voltammetry (CV) analysis was performed in N₂ saturated 1 M KOH solution. Before performing the linear sweep voltammetry (LSVs) at a scan rate of 2 mV s⁻¹, 20 cycles of CV were done at 50 mV s⁻¹ at room temperature. The overpotential value was calculated using the LSV plot, which was 65% iR corrected. For comparison, commercial RuO₂ and Pt/C catalysts were coated on NF of 1*1 cm² area with a loading of 3 mg cm⁻² and the analysis was done by keeping the similar condition. For overall water splitting analysis, 1*1 cm² of CoMoO₄@NiMoO₄·xH₂O/NF was used as both anode and cathode. The electrochemical surface area (ECSA) analysis was calculated by performing CV in the non-faradic region (0.2 V to 0.36 V) at different scan rates. The peak current obtained at 0.28 V is plotted against the corresponding scan rate gives a straight line, where the slope corresponds to the double-layer capacitance (Cdi) value. Using the specific capacitance (Cs) of the elements, the ECSA value can be calculated from the following equation,

$$ECSA = {C}_{dl} / {C}_{s} \qquad ( 1 )$$

The overall water splitting was performed with CoMoO₄@NiMoO₄·xH₂O/NF as both the electrodes. The amount of gas evolved during the overall water splitting was evaluated by using gas chromatography (GC), where 5700 Nucon gas chromatograph fitted with a thermal conductivity detector using argon as carrier gas. Carbosphere column was used for detecting the gases. Oven temperature was maintained at 50° C. and detector temperature of 100° C. during the measurement. 500 μL of gas from headspace was injected to GC using tight syringe.

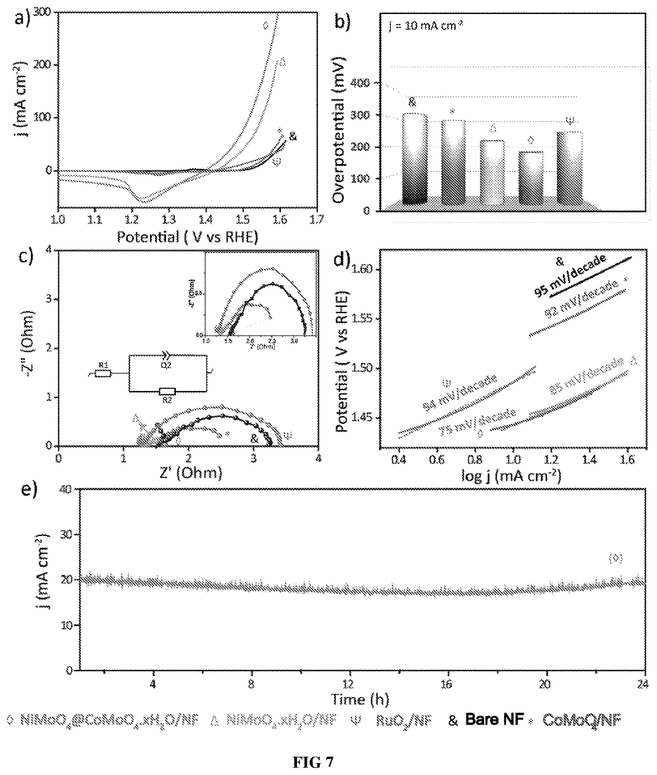

The electrochemical activity of both oxygen evolution reaction (OER) and hydrogen evolution reaction (HER) was investigated in 1 M KOH at 2 mV s⁻¹ scan rate using a three-electrode set-up. The 1*1 cm² area of synthesized material was used as the working electrode, Hg/HgO as reference electrode, and graphite rod as a counter electrode instead of Pt mesh to avoid platinum deposition on the working electrode. To reveal the OER activities of different catalysts, the linear sweep voltammogram (LSV) analysis was performed in N₂ saturated 1 M KOH at 2 mV s⁻¹ in a potential range of 1.0 V to 1.6 V (vs. reversible hydrogen electrode (RHE)). Due to the ohmic resistance, the measured current will not reflect the intrinsic behaviour of catalysts. Therefore, iR compensation was applied during the analysis.¹⁷ Before proceeding for LSV, 20 cycles of CV were performed in the potential window of 1.0 to 1.6 V vs. RHE under N₂ saturation. FIG. 7a displays the OER-LSV plot of NiMoO₄@CoMoO₄·xH₂O/NF, showing lowest overpotential of 180 mV to reach current density of 10 mA cm⁻² compared to bare NF (312 mV @ 10 mA cm⁻²) and its hybrid counterparts NiMoO₄·xH₂O/NF (220 mV @ 10 mA cm⁻²), Co—MoO₄/NF (290 mV @ 10 mA cm⁻²). Also, NiMoO₄@CoMoO₄·xH₂O/NF shows comparatively improved value concerning state-of-the-art RuO₂ coated on NF (RuO₂@NF), which needs 250 mV overpotential to reach 10 mA cm⁻². The significant OER activity of NiMoO₄@CoMoO₄·xH₂O/NF is due to synergistic interaction between its hybrid counterparts Ni—MoO₄·xH₂O/NF and CoMoO₄/NF. The dense NiMoO₄·xH₂O nanorod and its uniform coverage on NF make system super hydrophilic. Also, active site modulation as optimizing metal content creates interconnected network as explained in FESEM and 3D-tomography analysis for better mass transport. Then decoration of CoMoO₄ on NiMoO₄·xH₂O nanorods make electrode-electrolyte interaction more feasible for easy release of O₂ gas from electrocatalytically active surface. FIG. 7b shows comparative overpotential bar diagram, which concludes that CoMoO₄@NiMoO₄·xH₂O/NF displays improved OER activity compared to bare NF, Ni—MoO₄·xH₂O/NF, CoMoO₄/NF, and state of art RuO₂@NF at current density of 10 mAcm⁻².

The electrocatalytic kinetics and charge transfer between electrode-electrolyte during OER was understood by an EIS investigation at 1.56 V vs. RHE. FIG. 7c displays the corresponding Nyquist plots of CoMoO₄@NiMoO₄·xH₂O/NF, NiMoO₄·xH₂O/NF, CoMoO₄/NF, RuO₂@NF, and bare NF in the frequency range of 1 MHz to 100 MHz. The R_{CT} (the difference between R₂ and R₁) value calculated from the Nyquist plot of bare NF is 1.7Ω. But NiMoO₄@Co—MoO₄·xH₂O/NF shows a R_{CT} value of 0.2 Ω compared to NiMoO₄·xH₂O/NF (0.24 (2), Co—MoO₄/NF (1.1Ω), and RuO₂@NF (3.4 (2). The small R_{CT} value corresponds to faster electron transfer, which is consistent with the OER LSV plot. This lower resistance faced by Co—MoO₄@NiMoO₄·xH₂O/NF compared to its hybrid counterparts is due to the exposure of active sites in the hierarchical heterostructure. Here, the RuO₂ is showing a comparatively high R_{CT} value, it may be due to the low electrical conductivity of RuO₂@NF.⁸ The OER reaction kinetics is further analyzed by using Tafel plots. The Tafel equation η=a+b log j, where “n” denotes the overpotential, a is the Tafel constant, b is the Tafel slope and j is the current densities. The current densities in different potentials were calculated and the linear part is fitted in the above Tafel equation. FIG. 7d displays the Tafel slope of bare NF, NiMoO₄·xH₂O/NF, CoMoO₄/NF, RuO₂@NF and CoMoO₄@NiMoO₄·xH₂O/NF are 95 mV/decade, 85 mV/decade, 92 mV/decade, 94 mV/decade and 75 mV/decade. The lowest Tafel slope of CoMoO₄@Ni—MoO₄·xH₂O/NF further shows better kinetics for OER. The long-term durability of any catalyst is a parameter, which is directly proportionate to its catalytic efficiency in higher pH conditions i.e., 1 M KOH (corrosive condition). The Chronoamperometry (CA) analysis was done for 24 h at 20 mA cm⁻² at a potential of 1.49 V vs. (RHE) in FIG. 7e.

The HER activity of the synthesized materials was analyzed in 1 M KOH by using a standard three electrode set-up at a scan rate of 2 mV s⁻¹. FIG. 8a displays the comparative HER polarization curve of all the synthesized materials and state-of-the-art Pt/C coated on nickel foam (Pt/C@NF). The LSV of NiMoO₄@CoMoO₄·xH₂O/NF showing largest current and comparative overpotential of 356 mV to reach the higher current density of 100 mA cm⁻² compared to bare Ni foam (472 mV@100 mA cm⁻²) and its hybrid counterparts NiMoO₄·xH₂O/NF (453 mV@100 mA cm⁻²), CoMoO₄/NF (442 mV@100 mA cm⁻²). The state-of-the-art Pt/C coated on NF (Pt/C@NF), which needs 105 mV to reach 100 mA cm⁻². The remarkable increase in HER activity at higher current density of 100 mA cm⁻² of NiMoO₄@CoMoO₄·xH₂O compared to its hybrid counterparts is because of the well-interconnected network provide by Ni—MoO₄·xH₂O nanorods and the presence of well-decorated CoMoO₄ nanoparticles. The synergistic interaction (electron transfer) between these two hybrid counterparts, hydrophilic nature, and high electrochemical surface area provided by the well-interconnected active sites makes the system more feasible for HER performance.

To know about the electrocatalytic charge transfer resistance of electrode/electrolyte surface, an EIS investigation was done in 1 M KOH. FIG. 8c displays the corresponding Nyquist plots of the self-supported materials with state-of-the-art Pt/C coated on nickel foam (Pt/C@NF). The semicircles display the R_{CT} values of CoMoO₄@NiMoO₄·xH₂O/NF, NiMoO₄·xH₂O/NF, CoMoO₄/NF, Pt/C@NF, and bare NF in the frequency range of 1 MHz to 100 MHz V. The R_{CT} value calculated from the Nyquist plot of bare NF is 4.09Ω. NiMoO₄@CoMoO₄·xH₂O/NF shows a very small R_{CT} value of 1.11Ω compared to NiMoO₄·xH₂O (2.33Ω, CoMoO₄/NF (2.70Ω), and Pt/C@NF (0.37Ω). This lower R_{CT} value means faster electron transfer during HER of CoMoO₄@NiMoO₄·xH₂O/NF is in good agreement with the HER LSV plot. The HER reaction kinetics is further analyzed by using Tafel plots. FIG. 8d displays the Tafel slope of bare NF, NiMoO₄·xH₂O/NF, CoMoO₄/NF, CoMoO₄@NiMoO₄·xH₂O/NF and Pt/C@NF are 172 mV/decade, 156 mV/decade, 155 mV/decade, 142 mV/decade and 42 mV/decade. The lower Tafel slope for CoMoO₄@NiMoO₄·xH₂O/NF compared to its hybrid counterparts is furthe in line with the improved HER activity at higher current density. The Chronoamperometry (CA) analysis was done for 24 h at 20 mA cm⁻² a potential of −0.3 V vs. (RHE) in FIG. 8e. The hierarchical nanorods containing nanoparticles of CoMoO₄@NiMoO₄·xH₂O/NF are retained even after 24 h of stability operation.

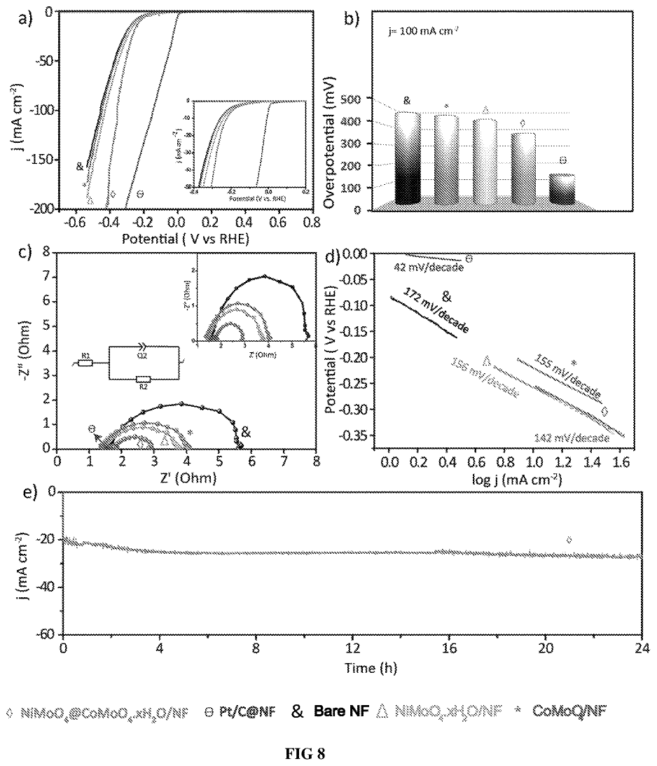

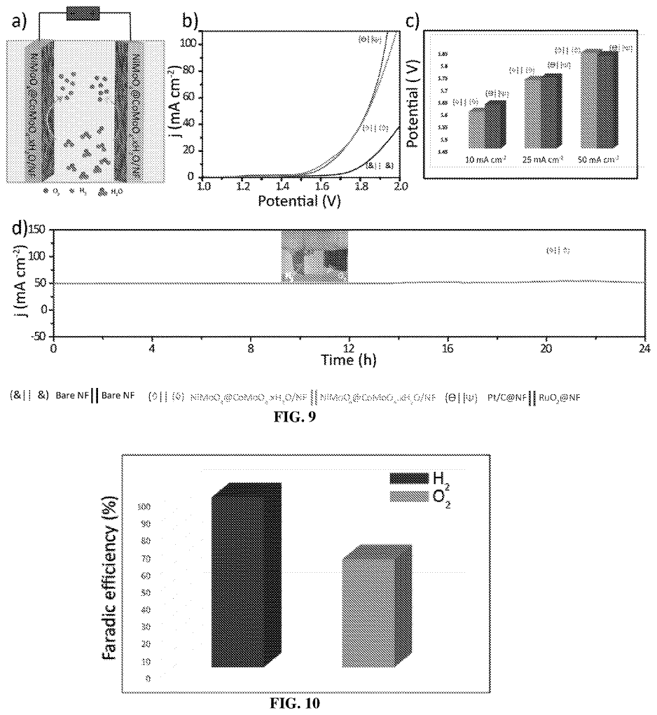

After all the electrochemical analyses for OER and HER, it is confirmed that CoMoO₄@Ni—MoO₄·xH₂O/NF can be employed as a bifunctional electrocatalyst for overall water splitting. In the overall water splitting operation, oxygen evolves at anode from OH in electrolyte by oxidation process and hydrogen evolve at cathode by the reduction of H₂O. FIG. 9 represents the overall water splitting performance of CoMoO₄@NiMoO₄·xH₂O/NF in 1 M KOH solution and compared with bare NF | Bare NF and state-of-the-art Pt/C@NF | RuO₂@NF. FIG. 9a represents the overall water splitting demonstration by using CoMoO₄@NiMoO₄·xH₂O/NF as both anode as well as cathode electrodes (1*1 cm² area) in 1 M KOH solution. In FIG. 9b, the overall water splitting by using bare NF I Bare NF is showing a very high voltage of 1.8 V to reach 10 mA cm⁻². However, the voltage required to reach 10 mA cm⁻² for CoMoO₄@Ni—MoO₄·xH₂O/NF | CoMoO₄@NiMoO₄·xH₂O/NF is 1.6 V, which is comparable with state-ofthe-art Pt/C@NF | RuO₂@NF (1.63 V @ 10 mA cm⁻²) and also better compared to many of the reported non-precious metal electrocatalysts (Table S1). In FIG. 9c, the overall water splitting performance, made up of CoMoO₄@NiMoO₄·xH₂O/NF requires 1.60 V, 1.73 V and 1.84 V to reach current densities of 10 mA cm⁻², 25 mA cm⁻² and 50 mA cm⁻², respectively. Whereas Pt/C@NF | RuO₂@NF based electrolyzer requires 1.63 V, 1.74 V and 1.83 V to reach current densities of 10 mA cm⁻², 25 mA cm⁻² and 50 mA cm⁻², respectively. So, it is confirmed from overall water splitting analysis that CoMoO₄@NiMoO₄·xH₂O/NF based system shows comparatively improved performance at 10 and 25 mA cm⁻² than Pt/C@NF | RuO₂@NF based overall water splitting. The operational durability is the main factor for performing long-time overall water splitting in corrosive 1 M KOH conditions. In FIG. 9d, CoMoO₄@Ni MoO₄·xH₂O/NF shows chronoamperometric analysis (CA) over 24 h operation at a constant current density of 50 mA cm⁻² and shows good stability.

Post analysis of electrodes containing said composite is done by FESEM, XRD and XPS analysis wherein the FESEM analysis of both cathode and anode after the long-run 24 h overall water splitting operation (After 24 h OWS-CA analysis), the morphology of the material was retained with some surface structure modification, which proves the robustness of the catalyst and there are nanoparticles covered above the heterostructure. The CoMoO4 (Co2+) suprastrum of CoMoO₄@NiMoO₄·xH₂O/NF electrode may converted into cobalt oxyhydroxide (Co3+) because of the well-known stability of Co3+ in KOH solution, which reflects in the phase of CoOOH in XRD analysis. To know the surface chemical modification, XPS investigation was done on CoMoO₄@NiMoO₄·xH₂O/NF after overall water splitting where the XPS survey scan spectrum confirms the presence of Ni, Mo, Co, and O elements after 24 h overall water splitting analysis. Moreover, with respect to pristine CoMoO₄@NiMoO₄·xH₂O/NF, the shift to lower binding energy in both anode and cathode confirms the formation of CoOOH nanoparticles on the surface of anode and cathode during overall water splitting. Also, there is expected presence of expected NiOOH nanoarrays as per the binding energy trend of post OWS anode Ni2p, and a slight change in Mo3d binding energy of post OWS anode. The in-situ modification of nanostructure and surface CoOOH nanoparticles provides anchoring sites for H+ and OH-ions adsorption, which again proves robustness and in-situ structural modification.

### Advantages and Applications of the Present Disclosure

The present disclosure provides a self-supported active site engineered superhydrophilic hierarchical CoMoO₄@NiMoO₄·xH₂O/NF composite having a high surface area with improved electrical conductivity. The present disclosure provides a self-supported active site engineered superhydrophilic hierarchical CoMoO₄@NiMoO₄·xH₂O/NF composite having the ability to facilitate better mass transport in the system. The present disclosure provides a self-supported active site engineered superhydrophilic hierarchical CoMoO₄@NiMoO₄·xH₂O/NF composite having better electrode-electrolyte interaction. The present disclosure provides a self-supported active site engineered superhydrophilic hierarchical CoMoO₄@NiMoO₄·xH₂O/NF composite having better catalytic activities for the overall water splitting. The present disclosure provides self-supported active site engineered superhydrophilic hierarchical CoMoO₄@NiMoO₄·xH₂O/NF composite that can be used in large scale application e.g., industrial scale production, due to its easy availability and non-toxicity. The present disclosure provides a self-supported active site engineered superhydrophilic hierarchical CoMoO₄@NiMoO₄·xH₂O/NF composite having NiMoO₄·xH₂O nanorods that act as highly conductive material and provides better surface area and charge transfer and above that CoMoO₄ nanoparticles decoration by simple hydrothermal method. The present disclosure provides a self-supported active site engineered superhydrophilic hierarchical CoMoO₄@NiMoO₄·xH₂O/NF composite having higher hydrophilicity with better morphology (nanorods @ nanoparticles) provides high exposure of interconnected active sites, synergistic interaction between the hybrid counter parts for easy diffusion of ion/electron and homogeneous distribution of active sites providing a suitable pathway for electrode/electrolyte interaction. The present disclosure provides a self-supported active site engineered superhydrophilic hierarchical CoMoO₄@NiMoO₄·xH₂O/NF composite having improved aerophobicity. The present disclosure provides a self-supported active site engineered superhydrophilic hierarchical CoMoO₄@NiMoO₄·xH₂O/NF composite having lesser resistance and higher current densities in electrochemical calculations than reported composite. The present disclosure provides a self-supported active site engineered superhydrophilic hierarchical CoMoO₄@NiMoO₄·xH₂O/NF composite having higher stability (at or above 24 hrs. stable). The present disclosure provides a self-supported active site engineered superhydrophilic hierarchical CoMoO₄@NiMoO₄·xH₂O/NF composite having higher robustness, and provides in-situ modification in structural features.

We claim:

1. A binder-free superhydrophilic composite for water electrolysis, said superhydrophilic composite comprises:
1^{st} bimetallic oxides component represented by: M₁M₂Ox,
2^{nd} bimetallic oxides component represented by: M₃M₄Oy, and
a 3D conductive support;
wherein said 2^{nd} bimetallic oxides component is deposited onto said 1^{st} bimetallic oxides component,
wherein M₁ is Ni; M₂ is selected from Co, Fe, and Mo; M₃ is selected from Co, Mn, Fe, and Cr; M₄ is selected from Mo, Co, Ni, Zn and W; x is in range of 1-9; and y is in range of 1-9, and
wherein, the 1^{st} bimetallic oxides component is in a nanorods shape, and the 2^{nd} bimetallic oxides component is in nanoparticles shape.

2. The superhydrophilic composite as claimed in claim 1, wherein the 1^{st} bimetallic oxides component is NiMoO₄; and wherein the 2^{nd} bimetallic oxides component is CoMoO₄.

3. The superhydrophilic composite as claimed in claim 1, wherein the 3D conductive support is selected from the group consisting of nickel Foam (NF), carbon cloth, titanium foil, copper foam, nickel mesh; wherein the M₁M₂Ox or NiMoO₄ nanorods has a thickness in the range of 180-400 nm; and the M₃M₄Oy or CoMoO₄ nanoparticles has a particle size in the range of 50-250 nm.

4. The superhydrophilic composite as claimed in claim 1, wherein the superhydrophilic composite comprises CoMoO₄·xH₂O nanoparticles deposited on NiMoO₄ nanorods that are supported on a nickel foam (CoMoO₄@NiMoO₄·xH₂O/NF).

5. A process of producing superhydrophilic composite as claimed in claim 1, said process comprising the steps of:
e. synthesizing a hydrophilic construction of M1M2Ox·xH2O nanorods on a support substrate by a hydrothermal method at 100-200° C. for 4 to 8 hrs; and
f. growing the M3M4Oy nanoparticles in-situ on the hydrophilic M1M2Ox·xH2O nanorods at 150-200° C., followed by washing and drying to obtain said hydrophilic composite (M3M4Oy@M1M2Ox/support).

6. A process of producing NiMoO₄@CoMoO₄·xH₂O/NF system as claimed in claim 5, said process comprising the steps of:
d. providing Ni(NO₃)₂·4H₂O, (NH₄)₆Mo₇O₂₄·4H₂O and Co(acac)₂·6H₂O precursors;
e. synthesizing hydrophilic construction of hydrophilic NiMoO₄·xH₂O nanorods on NF substrate using Ni(NO₃)₂·4H₂O precursor solution at pH of 6.7 as initiator for nanorod formation in presence of (NH₄)₆Mo₇O₂₄·4H₂O at 100-200° C. for 6 h; and
f. growing the CoMoO₄ nanoparticles in-situ on the hydrophilic NiMoO₄·xH₂O nanorods using Co(acac)₂·6H₂O and (NH₄)₆Mo₇O₂₄·4H₂O at at 150-200° C., followed by washing and drying to obtain CoMoO4@NiMoO4·xH2O/NF.

7. The process as claimed in claim 6, wherein ratio of Ni(NO₃)₂·4H₂O and (NH₄)₆Mo₇O₂₄·4H₂O homogenous solution in step b) is 4:1 to 12:3 M, respectively; and wherein ratio of Co(acac)₂·6H₂O and (NH₄)₆Mo₇O₂₄·4H₂O homogenous solution in step c) is 3:1 to 12:3 M, respectively.

8. A binfunctional electrode for water hydrolysis and production of green hydrogen through hydrogen evolution reaction and oxygen evolution reaction in an electrochemical device, comprising binder-free superhydrophilic composite as claimed in claim 1, wherein the electrode is cathode and/or anode; and wherein said composite is coated onto the electrode.

9. The bifunctional electrode as claimed in claim 8, wherein the electrochemical device exhibits overpotential of 180 mV to reach current density of 10 mA cm⁻² during oxygen evolution reaction; and overpotential of 356 mV to reach current density of 100 mA cm⁻² during hydrogen evolution reaction.

10. The binfunctional electrode as claimed in claim 8, wherein the cathode is made of NiFeO4, NiCo2O₄ or MnCo2O₄; and the anode is made of CoMON, FeMoO4 or CoWO4.

11. A half-cell comprising the binfunctional electrode as claimed in claim 8 as working electrode (WE), graphite rod as counter electrode and Hg/HgO as reference electrode.

12. A full-cell comprising the binfunctional electrode as claimed in claim 8 as anode and/or cathode, separator and electrolyte solution.

13. The full cell as claimed in claim 12, wherein the separator can is based on alkaline exchange membrane, selected from Fumatech F-PAA, Sustanion and Piper ion grade; and wherein the electrolyte solution comprises aqueous solution of 1M KOH.
